(19) United States
(12) Patent Application Publication
(10) Pub. No.: US 2001/0052594 A1
(43) Pub. Date: Dec. 20, 2001

(54) Device for lifting a track roller of a tracked vehicle

(76) Inventor: Jean-Pierre Eloy, Etreaupoint (FR)

Correspondence Address: BAKER & BOTTS, 30 ROCKEFELLER PLAZA, NEW YORK, NY, 10112

(21) Appl. No.: 09/922,898

(22) Filed: Aug. 6, 2001

Related U.S. Application Data
(63) Continuation of application No. PCT/EP00/12280, filed on Dec. 6, 2000.

(30) Foreign Application Priority Data
Dec. 7, 1999 (FR) 99/15506

(51) Int. Cl. B60S 9/02

(52) U.S. Cl. 254/422

(57) ABSTRACT

A roller lifting device for lifting a track roller of a vehicle equipped with tracks, each track being formed by a plurality of chain links connected in twos by means of connectors. This roller lifting device includes a lifting arm, one end of which co-operates with the axis of rotation of a roller mounted in rotary manner on a rocker and the other end of which is mounted pivotally on a shoe fixed temporarily to a connector located on the inside of the said track. This device also includes a second shoe fixed temporarily to that connector which is axially opposed to the connector to which the first shoe is fixed, and a coupling between the first and second shoes to keep the axial spacing between the shoes constant once the latter have been positioned on their respective connector and throughout the lifting operation so that the safety of the operation is ensured.

This is a continuation of PCT/EP00/12280, filed Dec. 6, 2000, published as WO 01/4278 on Jun. 14, 2001.

### BACKGROUND OF THE INVENTION

The invention relates to the field of tracked equipment having track rollers, and more particularly to a device for lifting the said track rollers in order to enable maintenance and/or replacement operations to be performed.

Various vehicles are known, in particular armored equipment driven by tracks tensioned between a tension pulley and a crown wheel (see FIG. 1, showing diagrammatically a sectional view of a tracked vehicle). Each track 1 has an internal rolling surface and an external rolling surface, the latter being in contact with the ground while the vehicle is moving. Each track 1 is formed by a plurality of metal chain links 11 (which can be seen in FIG. 2), each chain link extending in the transverse direction (that is to say the direction perpendicular to the direction in which the said track rotates), each chain link 11 being connected to those following it by metal connectors 12, 13 fixed by appropriate means on either side of the said chain links 11, so as to allow limited rotary movement of a chain link in relation to its adjacent chain links while the vehicle is moving. Two adjacent chain links are connected to one another by a first connector 13 placed in the central area, while two other connectors 12 are mounted on shafts 16 emerging laterally from the said chain links. Once in place, the connectors 12 project laterally from either side of each track, that is to say both from the inside and from the outside of the vehicle. Moreover, each chain link 11 has at least one tooth 14 forming a projection from the internal rolling surface of each track, the said teeth 14 being intended to co-operate with the track rollers 3 rolling on the internal surface to ensure that the said track is guided while the vehicle is moving. Each track roller 3, mounted on a rocker arm 4, is formed by the composite element of two roller halves 5 and 6 delimiting a groove (see FIG. 3) for guiding the teeth 14.

In certain applications, the metal chain links may have rubber pads 15 intended to come into contact with the ground while the vehicle is moving, in order to achieve a rolling action of the vehicle which is less aggressive with respect to the ground and to make the said rolling more comfortable (less noisy). A track of this kind for the metal part is in particular manufactured by the company DIEHL and distributed under the name KLEBER TRACK or DIEHL.

It is sometimes necessary to work on a tracked vehicle of this kind in order to perform maintenance or replacement operations on one of the track rollers. To this end, a roller must be lifted in order to move the track away from the said roller to be repaired or replaced. It is known to use a device for lifting a track roller, the said device having an arm whereof one end is provided with a fork intended to co-operate with the rocker of the roller to be lifted and whereof the other end may be mounted pivotally and temporarily on one of the chain links of the track. By displacing the vehicle slowly, an operator brings the fork of the arm into contact with the rocker in a first operation, and by continuing to displace the said vehicle, the part of the track in contact with the ground remaining fixed with respect to the said ground, the lifting arm forces the rocker to describe an arc in such a way that the roller borne by the said rocker is lifted. At this point, once the vehicle is immobilized, it is simple to work on the lifted roller.

In use, it has been found that the safety of operators using this type of roller lifting device could be jeopardized during the various maneuvers of lifting and lowering, or even during the maintenance operations on the lifted roller as the lifting arm could slide laterally against the chain link on which it was mounted pivotally. The safety of the operator may also be jeopardized by the fact that he must work underneath the vehicle to engage the lifting arm with the rocker of the roller to be lifted.

### SUMMARY OF THE INVENTION

The subject matter of the present invention is a device for lifting a track roller of a track having connectors which obviates the safety problems mentioned while employing the lifting principle briefly described above.

The roller lifting device according to the invention is intended to lift a track roller of a vehicle equipped with tracks, each track being formed by a plurality of chain links disposed next to one another in the direction in which the said track rolls, these chain links being connected in twos by means of connectors placed axially inside and outside with respect to the said chain links, each track having an external surface and an internal surface, the internal surface serving as a rolling surface for track rollers mounted in rotary manner on rockers which are themselves mounted pivotally on the vehicle, and the external surface being intended to come into contact with the ground. Each chain link forming the track is formed by a body having at least one guide tooth projecting from the internal surface of the track and a rubber pad fixed to the said chain link in such a way as to come into contact with the ground. The roller lifting device comprises a lifting arm in which one end is intended to co-operate with the rocker of the roller to be lifted and whereof the other end is mounted pivotally on a shoe fixed temporarily to a first connector located on the inside of the said track.

The device according to the invention further comprises:

a second shoe fixed temporarily to that connector which is axially opposed to the connector to which the first shoe is fixed;

coupling means between the first and second shoes to keep the axial spacing between the said shoes constant once the latter have been positioned on their respective connector and throughout the lifting operation so that the safety of the said operation is ensured.

The inside of a track of a tracked vehicle as used herein means the side of the track facing the other track of the vehicle.

The fact that two limbs adjoin the part of the inside shoe bearing the lifting arm, the said two limbs partly enclosing the lifting arm in its rotary movement, facilitates guiding of the said arm during the lifting operations, while at the same time further improving the safety of the device according to the invention during the various maneuvers.

Moreover, a vehicle as described above is very often subject to repeated jolts due principally to the unevenness of the terrain on which the said vehicle is moved. These jolts progressively lead to a flexural deformation of the rocker shafts, with the result that the said shafts are no longer perpendicular to the body of the vehicle, which causes an additional problem in hooking the fork of the lifting arm on the said rockers, which can in turn present another hazard. Advantageously, the internal face of the fork, that is to say a face on the side of the roller to be lifted, is on an incline not equal to zero in relation to a vertical plane, such that a line perpendicular to this face is substantially parallel to the direction of the rocker after deformation. This incline of the internal face is preferably effected by making the part of the lifting arm forming the fork progressively tapered.

### DESCRIPTION OF THE DRAWINGS

FIG. 1 is a schematic view of part of a vehicle equipped with two tracks;

FIG. 2 is a partial view of the track of FIG. 1 with metal chain links connected by connectors;

FIG. 3 is a partial view of the vehicle of FIG. 1, showing a track roller bearing on the internal surface of a track;

FIG. 4 is a view of the lifting device according to the invention in the position before lifting;

FIG. 5 is the device from FIG. 4 in the lifting position; and

FIGS. 6A and 6B are front and side views of an arm particularly suitable for lifting a track roller in which the rocker shaft is no longer perpendicular to the body of the vehicle.

### DESCRIPTION OF PREFERRED EMBODIMENTS

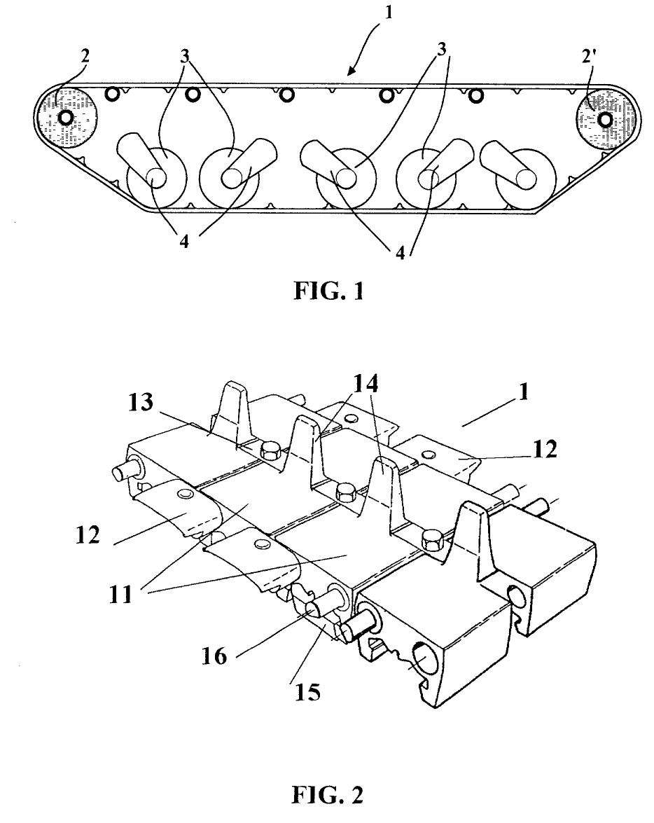

In FIG. 1, a tracked vehicle is shown in longitudinal section in a very schematic representation. A track 1 tensioned between a tension pulley 2 and a crown wheel 2′ and having five track rollers 3 intended to press the said track against the ground during movement can be seen, viewed from inside the vehicle. Each track roller 3 is formed by the composite element of two roller halves and is mounted in rotary manner at one end of a rocker 4 whereof the other end is mounted pivotally on the vehicle body (not shown in the present figure).

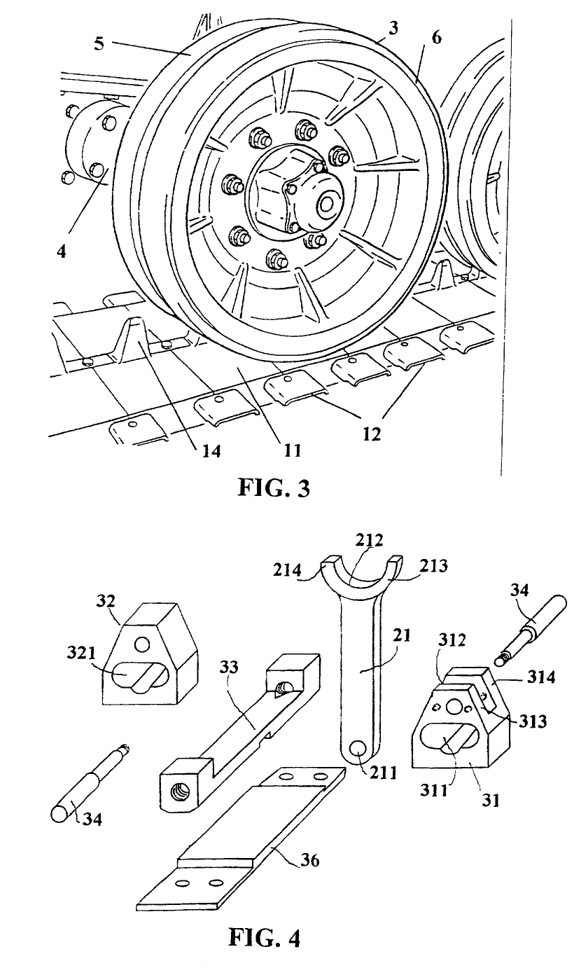

FIG. 2 shows a partial view of a track of the vehicle of FIG. 1; in this FIG. 2, there can be seen a plurality of metal chain links 11 provided on their internal face with a tooth 14 intended to co-operate with the track rollers and the tension pulleys to ensure that the said track is guided as can be seen in FIG. 3, which shows a track roller 3 in place on a track.

FIG. 4 shows an exploded perspective view of different parts forming the roller lifting device according to the invention. The roller lifting device according to the invention comprises:

a first outside shoe 32 intended to be placed on the track on the outside of the vehicle, this shoe 32 having an orifice 321, the cross-section of which is adapted to receive the end of a first connector to be inserted;

a second inside shoe 31 also having an orifice 311 so that it can receive the end of a second connector axially opposed to the first connector; in its top part, this inside shoe 31 has a groove 312 defined between two limbs 313 and 314;

a spacer element 33 placed between the first and second shoes 31 and 32 and fixed to the said shoes by means 34 for keep the spacing between the said shoes constant;

a base plate 36 serving to support the two shoes 31 and 32 and intended to be placed between the ground and the track.

Furthermore, the roller lifting device comprises a lifting arm 21, one end 211 of which is provided to be mounted inside the groove 312 in the inside shoe 31, pivotally about a pivot axis which passes perpendicularly through the two limbs 313 and 314 (in the present case, the means 34 of fixing the inside shoe 31 to the spacer element 33 plays the part of a pivot axis). The other end 212 of the lifting arm 21 has a two-pronged fork 213, 214 intended to co-operate with the end of a roller-bearing rocker in order to lift the said roller. The two ends 211, 212 of the arm define the longitudinal direction of the said arm. In practice, the roller lifting device is positioned in that part of the track located between one of the tension pulleys and the first track roller by assembling the different parts making up the said device around the track, so that when the vehicle is moved the device remains locked in position with the track and comes into contact with the ground. At this point, the fork of the lifting arm is positioned such that it co-operates with the end of the rocker bearing the roller to be lifted. After lifting and maintenance have been performed, the same procedure is carried out in reverse.

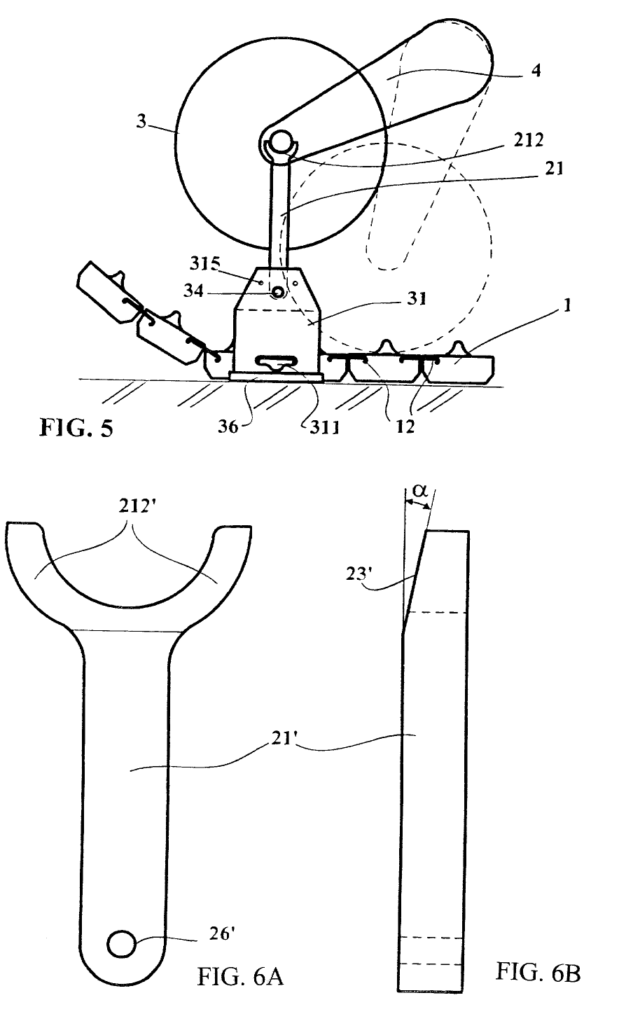

FIG. 5 shows the device according to the invention in its final position of lifting a track roller 3. In this FIG. 5, the lifting device is shown as seen from inside the vehicle; a connector 12 engages with the inside of the orifice 311 provided in the inside shoe 31, the said shoe being locked in position with the track 1 as a result of the presence of an outside shoe (not visible) to which it is connected mechanically by means of a spacer element. The lifting arm 21 mounted pivotally about the axis 34 is in a vertical position with respect to the ground; the fork 212 of the lifting arm 21 co-operates with the shaft of the roller 3 on the rocker 4 to keep the roller sufficiently far away to allow work on the said roller. The rocker 4 and the track roller 3 are shown in dashed lines in their bottom position, that is to say in the position of rolling.

The base plate 36 is mounted on the outside surface of the track to come into direct contact with the ground and thus to provide better seating for the lifting device and consequently a higher degree of safety; means are provided to connect this base plate mechanically to each inner and outer shoe.

In order to avoid the need for an operator to be present to engage the fork of the arm on the rocker at the time of moving the vehicle forward to perform the lifting operation, it is provided for a pin to be positioned in the appropriate orifices 315 made in the two limbs 313 and 314 of the inside shoe 31. In this way, after the device has been put in position and before the vehicle is moved forward, the lifting arm is brought to bear against the pin and is inclined above the horizontal towards the rocker such that, before the vehicle is moved forward, the said arm may be engaged on the rocker automatically, without the need for work by an operator.

FIG. 6 shows a plan view and a profile view of a variant of a lifting arm which provides the advantage that it can be adapted to lift the track roller mounted on a rocker, the said rocker having deformations resulting from stresses undergone when the vehicle is in motion. These stresses cause a greater or lesser flexural deformation of each rocker, which manifests itself in the fact that the axis of rotation of the roller mounted on the said rocker is no longer in a horizontal plane with respect to the ground. To allow the fork 212′ of the lifting arm 21′ to engage with the axis of a roller even if the latter is no longer in a horizontal plane with respect to the ground, one of the faces 23′ of the fork 212′ is planar and forms an angle α not equal to zero with the longitudinal direction of the said arm. In this way, it is possible to engage the fork of the lifting arm with the axis of the track roller with the necessary degree of safety.

I claim

1. A roller lifting device for lifting a track roller of a vehicle equipped with tracks, each track being formed by a plurality of chain links disposed next to one another in the direction in which the said track rolls, these chain links being connected in twos by means of connectors placed axially inside and outside, each track having an external surface and an internal surface, the internal surface serving as a rolling surface for track rollers, each track roller being mounted in rotary manner about an axis borne by a rocker and the external surface contacting the ground, each chain link being formed by a body having at least one guide tooth projecting from the internal surface of the track, the roller lifting device comprising a lifting arm, one end of which co-operates with the axis of rotation of the said roller on the rocker and the other end of which is mounted pivotally on a first shoe fixed temporarily to a first connector located on the inside of the said track, the device further comprising:
a second shoe fixed temporarily to that connector which is axially opposed to the connector to which the first shoe is fixed; and
coupling means between the first and second shoes to keep the axial spacing between the said shoes constant once the latter have been positioned on their respective connector and throughout the lifting operation so that the safety of the said operation is ensured.

2. A roller lifting device according to claim 1 wherein the coupling means between the first and second shoes comprise a spacer element and means fixing the said spacer element to each of the said shoes.

3. A roller lifting device according to claim 2 including a base plate disposed between the inside and outside shoes and the outside surface of the track such that it comes to bear against the ground to provide better seating for the said device.

4. A roller lifting device according to one of claim 1 wherein the shoe bearing the lifting arm has at one of its ends two limbs forming a groove for guiding the lifting arm in its rotary movement about its pivot axis passing through the two limbs.

5. A roller lifting device according to claim 1 wherein the end of the lifting arm which cooperates with the rocker of the roller to be lifted has a fork, the said end having an inside face located on the side of the roller to be lifted and being at an incline a not equal to zero in relation to any plane containing the longitudinal direction of the lifting arm such that a straight line perpendicular to this face is substantially parallel to the direction of the axis of the rocker to compensate for any deformation of the latter.

6. A roller lifting device according to claim 1 including a pin passing through that shoe on which the lifting arm is mounted in order to maintain the said arm in a position inclined in the direction of the rocker of the roller to be lifted such that the need for work by an operator is avoided and thus the degree of safety of the lifting operation is increased.
